(19) United States
(12) Patent Application Publication
(10) Pub. No.: US 2004/0205553 A1
(43) Pub. Date: Oct. 14, 2004

(54) Page layout markup language

(76) Inventors: David M. Hall, Camas, WA (US); Jacob G. Refstrup, Portland, OR (US); Brett Phillip Graves, Vancouver, WA (US)

Correspondence Address: Hewlett-Packard Company, Intellectual Property Administration, P.O. Box 272400, Fort Collins, CO, 80527-2400, US

(21) Appl. No.: 09/930,776

(22) Filed: Aug. 15, 2001

(51) Int. Cl. G06F 15/00

(52) U.S. Cl. 715/513; 715/517

(57) ABSTRACT

A page layout markup language provides a syntax that allows an author to create a document using a plurality of definitions. In one implementation, a document definition references at least one section. A section definition, contained within the document definition, references at least one page. A page definition, contained within the section definition, references at least one region. A region definition, contained within the page definition, is used to display content.

### TECHNICAL FIELD

This disclosure relates to a page layout markup language. More particularly, this disclosure relates to an SGML (Standard Generalized Markup Language) compliant DTD (document type definition).

### BACKGROUND

It is frequently the case that there is a desire to view or print content generated by a content author and supplied by a content provider. The content may include a news article, an instruction manual or any other type of document. The content provider may be an Internet site, a server on a local area network (LAN) or other location from which content is distributed.

One or more problems may be encountered when a content consumer attempts to view or print the document. A typical problem results from the assumptions made by the either the content author or the content provider in the preparation, formatting and transmission of the document and the expectations of the content consumer's computer, application software, browser or printer. For example, the content author may indicate a specific paper size and margin value to be used in the printing of a portion of the document. If the content consumer's printer does not have that paper size available, or cannot print as close to the edge of the page as required, an error may result in the rendering of the document. Other circumstances could similarly generate additional error messages. Accordingly, specific requirements contained within documents may result in difficulties for the information consumer.

From the point of view of the content author, restrictions on the manner in which content may be presented may interfere with the author's ability to express an idea. Similarly, requirements inherent within known document formats may detract from the commercial or artistic value of the document. Moreover, due to system incompatibilities, rules of authorship may at times be conflicting. Accordingly, specific requirements within known documents may burden an author's ability to effectively communicate with an audience.

### SUMMARY

A page layout markup language provides a syntax that allows an author to create a document using a plurality of definitions. In one implementation, a document definition references at least one section. A section definition, contained within the document definition, references at least one page. A page definition, contained within the section definition, references at least one region. A region definition, contained within the page definition, is used to display content in a manner that allows content to flow between regions according to each region's capacity.

### BRIEF DESCRIPTION OF THE DRAWINGS

The same numbers are used throughout the drawings to reference like features and components.

FIG. 1 is an illustration of processes, organized in a sequence, corresponding to a typical printing algorithm.

FIG. 2 illustrates a network environment utilizing a version of a page layout markup language.

FIG. 3 is a diagram illustrating an exemplary syntax by which a version of the page layout markup language may be implemented.

FIG. 4 is a first exemplary document according to a version of a page layout markup language.

FIG. 5 is a second exemplary document according to a version of a page layout markup language.

FIG. 6 is a third exemplary document according to a version of a page layout markup language.

FIG. 7 is a flow diagram illustrating a method by which an exemplary version of a page layout markup language can be used to author a document.

FIG. 8 is a flow diagram illustrating a method by which an exemplary version of a page layout markup language can be used to print or otherwise output a document.

### DETAILED DESCRIPTION

A page layout markup language (PLML) provides a syntax that allows an author to create a document using a plurality of definitions. In particular, the page layout markup language allows the author to better control the layout of the content. In this manner, the author is better able to advantageously display content. In one implementation, a document definition references at least one section. A section definition, contained within the document definition, references at least one page. A page definition, contained within the section definition, references at least one region. A region definition, contained within the page definition, is used to display content. Where more than one region is defined, a link between the regions may be used to allow content to flow between regions, according to the availability of space within the regions and the space requirements of the content. Similarly, links between sections and pages allow content to flow between linked section and linked pages, respectively.

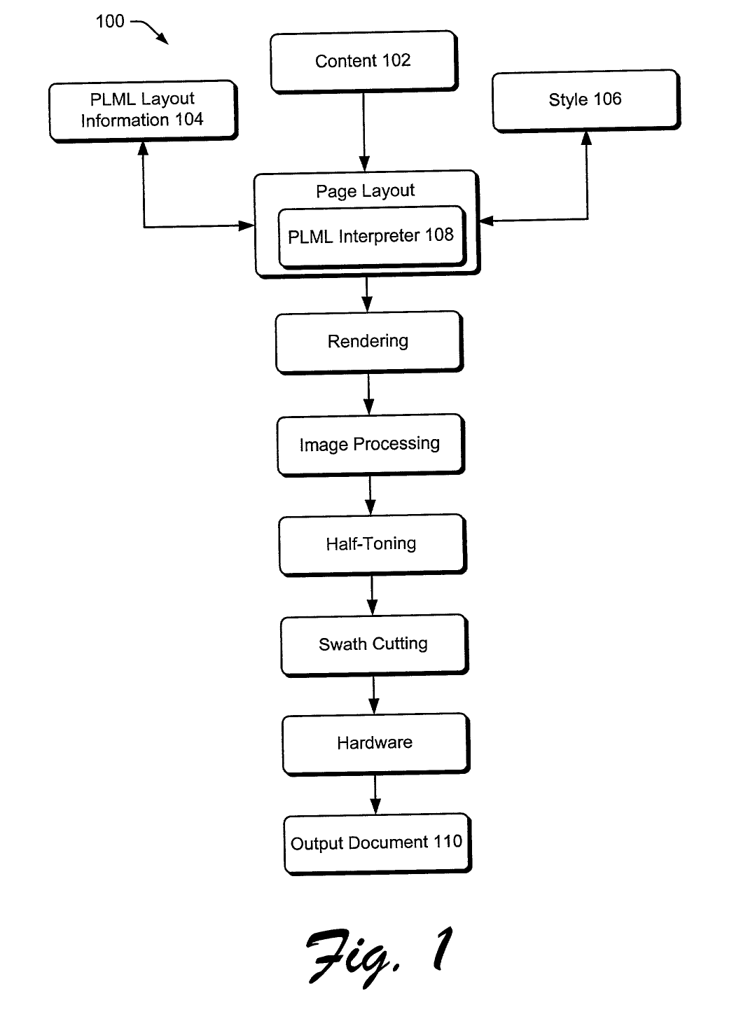

FIG. 1 shows a sequential process 100 corresponding to a printing algorithm. The printing algorithm processes the author's intended content, style and layout information into a form that may be conveniently printed. An analogous sequential process can be utilized to process content, style and layout information into information for display on a computer screen or other display apparatus. In both cases, the processing performed may be influenced by the characteristics of the hardware and software available. In spite of these influences, the information is processed in a manner that results in the least alteration of the author's intent consistent with the printing or video display environment.

The process 100 includes exemplary steps, such as page layout, rendering, image processing, half-toning, swath cutting and hardware processes. According to the process 100, input information is processed into an output document 110, which can be a printed document or a video image. These tasks are typically divided between the host that generates the content, style and layout and the client that is ultimately responsible for displaying or printing the information after processing has occurred. The location in the pipeline that the division occurs is typically where the I/O is placed. While different locations for placement of the I/O are possible, it is sometimes the case that the client device has more processing power than the host; when this is the case, the I/O should be placed in a location wherein the client's processing power can be utilized to relieve the host of this unwanted burden.

Within an exemplary print output environment, content 102 is delivered to the sequential process 100 by which an output document is produced. During the page layout processing, PLML layout information 104 and style information 106 are accessed as needed. In one implementation, an xHTML file is used for content, a CSS2 (cascading style sheet) file is used for style and the page layout markup language information, as discussed in greater detail below, is used for layout. Examples of content include strings of text and graphic images. Examples of style include underlining, italics and font use. Examples of layout information include the width of various margins, and the size and shape of text columns, and the characteristics, location and alignment of graphical images.

In the example of FIG. 1, a PLML (page layout markup language) interpreter 108 may be contained within the page layout portion of the process 100. As will be seen in greater detail, the PLML interpreter interprets the PLML commands contained within the PLML layout file 104, thereby controlling the layout of the final document 110.

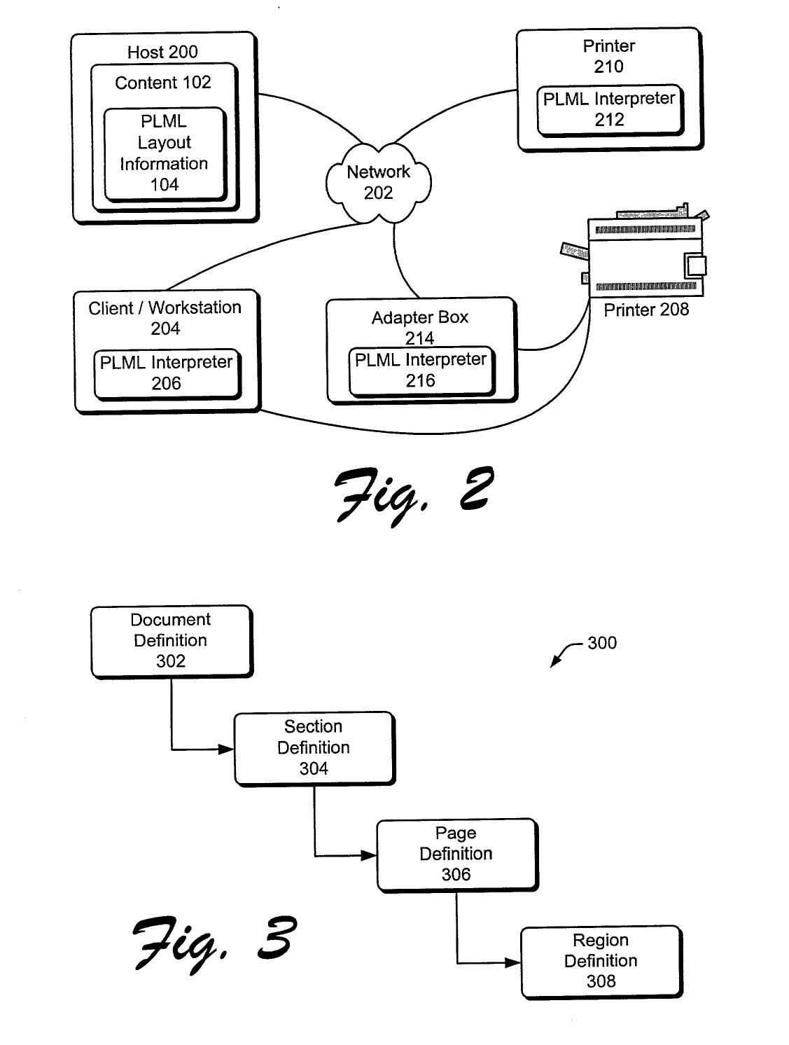

FIG. 2 illustrates a network environment utilizing a version of a page layout markup language. A host 200 contains a content-containing document 102 having PLML layout information 104 contained within the document or included as a distinct PLML file.

The content 102 and PLML layout information can be passed over the network 202 to a client or workstation 204, where the document can be viewed on the screen of the workstation 204. A PLML interpreter 206 interprets the commands of the included PLML information or the distinct PLML file 104. Accordingly, the PLML interpreter is able to process the layout information to advantageously display the document on the client's video display.

Alternatively, upon receipt of the content 102, the user of the workstation 204 may wish to print a document file to obtain a hard copy. Where a printer 208 is directly connected to the workstation, and a PLML interpreter 206 is available, the document may be processed by a printer driver and sent directly to the printer. In a third alternative, the document may be sent over the network 202 to a remote printer 210 having a PLML interpreter 212 resident on the printer. The content 102, having PLML information 104, is then printed by the printer 210 with the aid of the PLML interpreter 212.

In a fourth alternative, the content 102 having PLML information 104 may be sent to an adapter box 214 having a PLML interpreter 216 that is associated with a printer 208 not having a resident PLML interpreter. The adapter box processes the file with the aid of the PLML interpreter, and passes the output to the printer.

FIG. 3 shows an exemplary syntax 300 by which a version of the page layout markup language (PLML) may be implemented, thereby creating a PLML document. PLML documents can be processed by a PLML interpreter, a PLML plug-in for installation on a device such as a printer or workstation or in any manner consistent with processing a document type definition.

A document definition 302 allows an author to define characteristics of the document. These characteristics may include one or more sections, selection or rejection of duplex (two-sided) printing, and selection of landscape or portrait printing. A section definition 304 allows the author to define characteristics of the section. These characteristics may include a section name, specification of one or more page types within the section, an optional nextsection, margins and margin units. A page definition 306 allows the author to define characteristics of the page. These characteristics may include a page name, specify one or more regions within the page and an optional nextpage reference. A region definition 308 allows the author to define characteristics of the region. These characteristics may include a region name, a location within a page for the region, the data type contained within the region, resources to allow assignment of absolute and/or relative values to margin parameters, and resources to allow control over image processing operators, such as z-order (i.e. the priority by which regions either overlap, or are overlapped by, other regions), shrink-to-fit, maintain-aspect-ratio, and clip.

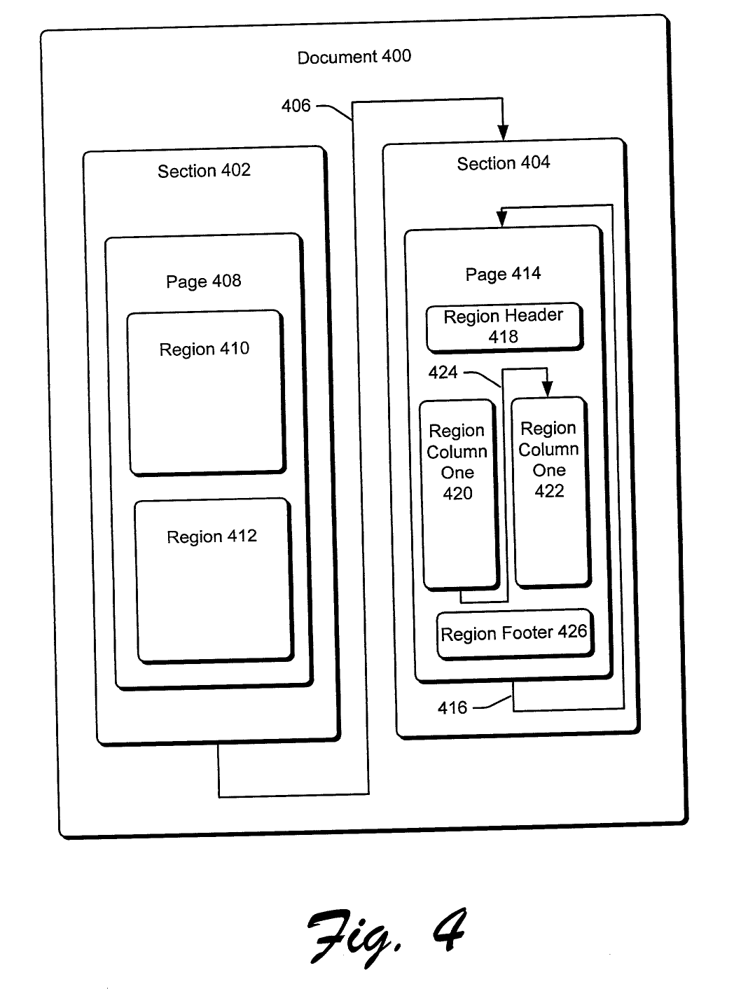

FIG. 4 shows an exemplary document 400 which could be created by use of the syntax 300 described above. The document includes two sections 402, 404. A link between the sections, link 406, is associated with the nextsection capabilities within the section definition 304. Within the first section 402, a single page 408 is defined. Page 408 includes two regions 410 and 412.

The second section 404 includes a plurality of similar pages 414 having a link 416 associated with the nextpage capabilities within a page definition 306. A header region 418 is defined within a definition associated with the page 414. Two column regions 420, 422 are similarly defined. A footer region 426 is also defined within the page 414. A link 424 is associated with the nextregion capabilities within the region definition. Use of the links 406, 416 and 424 facilitate the flowing of text or other content from one section, page or region to another section, page or region, respectively, as required, to format the document advantageously. For example, when one region becomes filled to capacity with text or other content, additional content is added to the region specified by the filled region's nextregion definition.

TABLE 1

```
<!ELEMENT DOCUMENT (SECTION+)>
<!ATTLIST DOCUMENT
  DUPLEX (1|0) “0”
  ORIENTATION (Landscape|Portrait) “Portrait”
>
  <!ELEMENT SECTION (PAGE+,NEXTSECTION?)>
    <!ATTLIST SECTION
```

| | | |
|---|---|---|
| SECTIONNAME | CDATA | #REQUIRED |
| LEFTMARGIN | CDATA | #REQUIRED |
| RIGHTMARGIN | CDATA | #REQUIRED |
| TOPMARGIN | CDATA | #REQUIRED |
| BOTTOMMARGIN | CDATA | #REQUIRED |

| | |
|---|---|
| MARGINUNITS | (NORMALIZED \| INCH \| |
| | CENTIMETER \| POINTS) |

“NORMALIZED”

| > | | |
|---|---|---|
| <!ELEMENT PAGE (REGION+,NEXTPAGE?)> | | |
| <!ATTLIST PAGE | | |
| PAGENAME CDATA #REQUIRED | | |
| > | | |
| <!ELEMENT REGION (LOCATION, | | |
| (XHTML_CONTENT\|IMAGE_CONTENT\| | | |
| TEXT_CONTENT), | | |
| NEXTREGION?)> | | |
| <!ATTLIST REGION | | |
| REGIONNAME CDATA #REQUIRED | | |
| VALIGN (TOP\|CENTER\|BOTTOM) “TOP” | | |
| HALIGN (LEFT\|CENTER\|RIGHT\| | | |
| JUSTIFIED) “LEFT” | | |
| ZORDER | CDATA | “1” |
| ROTATION | CDATA | “0” |
| SHRINKTOFIT | (1\|0) | “1” |
| MAINTAINASPECTRATIO | (1\|0) | “1” |
| CLIP (1\|0) “0” | | |

| > | | |
|---|---|---|
| <!ELEMENT LOCATION EMPTY> | | |
| <!ATTLIST LOCATION | | |
| X1 | CDATA | #REQUIRED |
| Y1 | CDATA | #REQUIRED |
| X2 | CDATA | #REQUIRED |
| Y2 | CDATA | #REQUIRED |

```
            UNITS  (NORMALIZED | INCH |
              CENTIMETER | POINTS)
```

“NORMALIZED”

```
          >
          <!ELEMENT XHTML_CONTENT EMPTY>
            <!ATTLIST XHTML_CONTENT
              URI  CDATA #REQUIRED
            >
          <!ELEMENT IMAGE_CONTENT EMPTY>
            <!ATTLIST IMAGE_CONTENT
              URI CDATA #REQUIRED
              IMGWIDTH CDATA “0”
              IMGHEIGHT CDATA “0”
              TYPE  (JPEG|GIF|PNG) “JPEG”
            >
          <!ELEMENT TEXT_CONTENT (#PCDATA)>
          <!ELEMENT NEXTREGION (#PCDATA)>
        <!ELEMENT NEXTPAGE (#PCDATA)>
      <!ELEMENT NEXTSECTION (#PCDATA)>
```

Table 1 shows specific details of one implementation of the exemplary syntax 300 suitable for creation of a document similar to that seen in FIG. 4. Referring to Table 1, the syntax of the document definition 302 allows an author to define one or more sections. The SECTIONS+ nomenclature indicates that this implementation allows at least one section to be included within the document. The DUPLEX (1|0) notation allows the author to invoke duplex printing using a “1” or single-sided printing by using a “0.” Similarly, the author may select landscape or portrait printing.

Continuing to refer to table 1, the syntax of the section definition 304 allows the author to define characteristics of the section. The PAGE+ nomenclature indicates that this implementation allows at least one page be included within the section. The NEXTSECTION? nomenclature indicates that a section definition can have zero or one NEXTSECTION elements. The NEXTSECTION element consists of character data that is used to specify the next logically linked section, to which excess content is to flow. The mechanism by which the link is made involves comparison of the NEXTSECTION element of the first section to the SECTIONNAME attribute of the second section. For example, excess content data within a first section flows to a second section, wherein the first section's NEXTSECTION element data matches the second section's SECTIONNAME attribute.

The attribute list allows the author to include the section name, margin values and margin units. The values “inch,” “centimeter” or “points,” are resources that allow the author to select absolute values with which to define margin values. Alternatively, the “normalized” selection is a resource that allows the author to select a value that is correct relative to the resources available. For example, the normalized or relative value will set the margins according to the space that is available. Thus, where a greater or lesser amount of space is available, the margins will be set to greater or lesser width or height. As a result of this flexibility, it is generally the case that the overall appearance of a document is increased.

Continuing to refer to table 1, the syntax of the page definition 306 allows the author to define characteristics of the page. The REGION+ nomenclature indicates that this implementation allows at least one region be included within the page. The NEXTPAGE? nomenclature indicates that a page definition can have zero or one NEXTPAGE elements. The NEXTPAGE element consists of character data that is used to specify the next logically linked page, to which excess content is to flow. The mechanism by which the link is made involves comparison of the NEXTPAGE element of the first page to the PAGENAME attribute of the second page. For example, excess content data within a first page flows to a second page, wherein the first page's NEXTPAGE element data matches the second page's PAGENAME attribute. The page definition also includes an attribute list, which allows the author to include the page name in a character format in the PAGENAME attribute.

Still referring to table 1, the syntax of the region definition 308 allows the author to define characteristics of the region. The LOCATION nomenclature indicates that the attribute list allows specification of a specific location within a page wherein the region is defined. The XHTML_CONTENT, IMAGE_CONTENT, TEXT_CONTENT nomenclature indicates that the author may specify content from among these types. For example, the region may be specified to contain XHTML, image or text content. The NEXTREGION? nomenclature indicates that a region definition can have zero or one NEXTREGION elements. The NEXTREGION element consists of character data that is used to specify the next logically linked region, to which excess content is to flow. The mechanism by which the link is made involves comparison of the NEXTREGION element of the first region to the REGIONNAME attribute of the second region. For example, excess content data within a first region flows to a second region, wherein the first region's NEXTREGION element data matches the second region's REGIONNAME attribute. The attribute list allows assignment of a region name. Also, vertical and horizontal alignment may be selected from among (top, center, bottom) and (left, center, right, and justified), respectively. The ZORDER allows association of each region with a value, thereby specifying a hierarchy by which it may be determined whether a first region overlaps, or is overlapped by, a second region. The author may specify that the content to be displayed in the region may be rotated or shrunk to fit. Similarly, the author can specify that the aspect ratio is maintained or allowed to be altered, or specify if the content may be clipped, if necessary.

The location of the region may be specified by use of the X1, Y1, X2 and Y2 elements. The units associated with the elements may be normalized, inch, centimeter or points. Again, normalized would be a relative unit, wherein the resources, including particularly space available, would be considered before assigning actual values. The other units would be considered to be absolute, and would not be subject to interpretation.

The URI of an XHTML document can be specified in character data. Typically, this involves a server name, a path to a document and a document name, in a manner that is consistent with the definition of a URI (uniform resource identifier) or a URL (uniform resource locator).

URI of an image may be specified in character data. Typically, this involves a filename and extension, such as image1.jpg. The image width and height may also be specified, and the author may select from among JPEG, GIF and PNG file types.

Text content may be imbedded within the TEXT_CONTENT element within the associated region as character data.

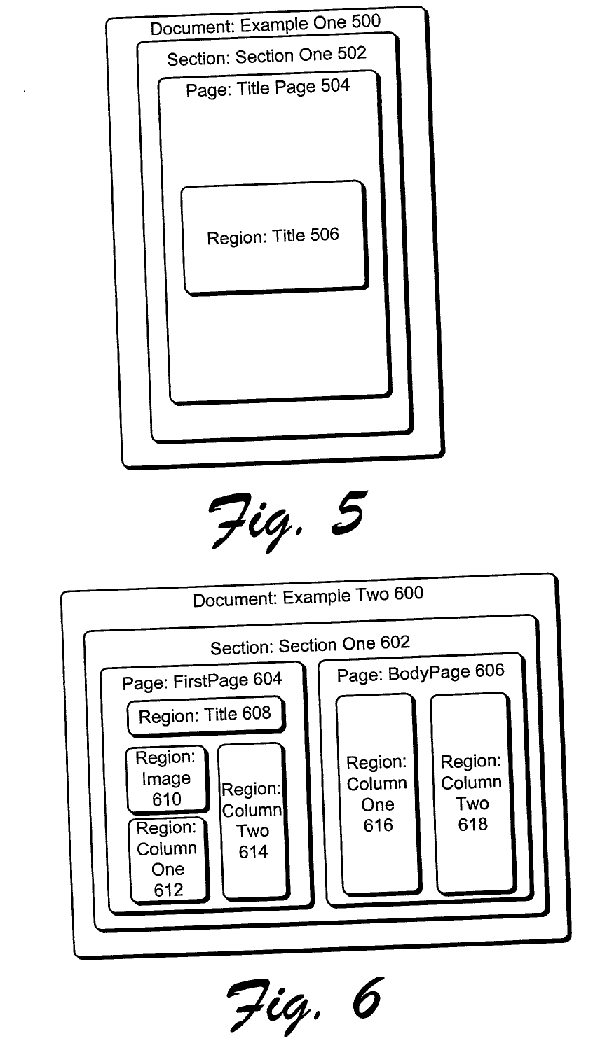

FIG. 5 shows an exemplary document 500 which could be created by use the syntax of Table 2. The document 500 includes a single section 502, labeled Section One. A single page 504, labeled Title Page, includes a single region 506, labeled Title.

TABLE 2

```
<?xml version=“1.0”?>
<!DOCTYPE DOCUMENT SYSTEM “example2.dtd”>
<DOCUMENT DUPLEX=“1” ORIENTATION=“Portrait”>
  <SECTION SECTIONNAME=“Section1”
    LEFTMARGIN=“0.25”
    RIGHTMARGIN=“0.25”
    TOPMARGIN=“0.25”
    BOTTOMMARGIN=“0.25”
    MARGINUNITS=“INCH”>
    <PAGE PAGENAME=“TitlePage”>
    <REGION REGIONNAME=“Title”
      VALIGN = “CENTER”
      HALIGN = “CENTER”
      ZORDER = “1”
      ROTATION = “0”
      SHRINKTOFIT = “0”
      MAINTAINASPECTRATIO = “1”
      CLIP = “0”>
      <LOCATION X1=“0.1”
        Y1=“0.1”
        X2=“0.9”
        Y2=“0.5”
        UNITS=“NORMALIZED”/>
      <XHTML_CONTENT URI=“http:\\www.example.com\
      xhtml_basic\cover.xml”/>
    </REGION>
    </PAGE>
  </SECTION>
</DOCUMENT>
```

Table 2 shows specific details of one implementation of the exemplary syntax 300 suitable for creation of a document similar to that seen in FIG. 5. Referring to Table 2, a filename and extension, example2.dtd is assigned to the document. Duplex (two-sided) printing and portrait paper orientation are selected. A single section, Section1, is defined. All four margins are assigned a value of 0.25 inches. A single page, TitlePage, is defined.

Continuing to refer to Table 2, a single region, Title, is defined. The region is vertically and horizontally centered. The ZORDER is set to “1,” although no other regions exist within the page that may overlap, or be overlapped by, the region Title. Rotation, shrink-to-fit and clipping are turned off; maintain-aspect-ratio is turned on. The location of the region is specified by x and y coordinates. The units are set to “normalized,” thereby allowing resources within the page layout markup language to assign “relative” values to the location coordinates, i.e. values which may be adjusted proportionally to reflect the specified x and y coordinates as modified by constraints such as available space. XHTML content is specified from a file listed with a URL or URI associated with the “example.com” website. The region, page, section and document definitions are then closed.

FIG. 6 shows an exemplary document 600 which could be created by use of the statements contained within Table 3. The document 600 includes one section, Section One 602. Section One includes two pages, FirstPage 604 and BodyPage 606. FirstPage includes four regions: Title 608, Image 610, Column One 612 and Column Two 614. BodyPage 606 includes two regions: Column One 616 and Column Two 618.

```
TABLE 3
<?xml version=“1.0”?>
<!DOCTYPE DOCUMENT SYSTEM “example3.dtd”>
<DOCUMENT DUPLEX=“1” ORIENTATION=“Portrait”>
  <SECTION SECTIONNAME=“Section1”
    LEFTMARGIN=“0.25”
    RIGHTMARGIN=“0.25”
    TOPMARGIN=“0.25”
    BOTTOMMARGIN=“0.25”
    MARGINUNITS=“INCH”>
    <PAGE PAGENAME=“FirstPage”>
    <REGION REGIONNAME=“Title” VALIGN =
    “CENTER” HALIGN = “CENTER”>
      <LOCATION X1=“0” Y1=“0” X2=“1” Y2=“0.2” />
      <IMAGE_CONTENT URI=“titlebar.jpg” TYPE=“JPEG” />
    </REGION>
    <REGION REGIONNAME=“Image1” VALIGN =
    “CENTER” HALIGN = “CENTER”>
      <LOCATION X1=“0” Y1=“0.25” X2=“0.45” Y2=“0.4” />
      <IMAGE_CONTENT URI=“image1.jpg” TYPE=“JPEG” />
    </REGION>
    <REGION REGIONNAME=“Column1”>
      <LOCATION X1=“0” Y1=“0.45” X2=“0.45” Y2=“1” />
      <XHTML_CONTENT URI=“body.xml” />
      <NEXTREGION>Column2</NEXTREGION>
    </REGION>
    <REGION REGIONNAME=“Column2”>
      <LOCATION X1=“0.55” Y1=“0.25” X2=“1” Y2=“1” />
      <NEXTREGION>Column1</NEXTREGION>
    </REGION>
    <NEXTPAGE>BodyPage</NEXTPAGE>
    </PAGE>
    <PAGE PAGENAME=“BodyPage”>
    <REGION REGIONNAME=“Column1”>
      <LOCATION X1=“0” Y1=“0” X2=“0.45” Y2=“1” />
      <NEXTREGION>Column2</NEXTREGION>
    </REGION>
    <REGION REGIONNAME=“Column2”>
      <LOCATION X1=“0.55” Y1=“0” X2=“1” Y2=“1” />
      <NEXTREGION>Column1</NEXTREGION>
    </REGION>
    <NEXTPAGE>BodyPage</NEXTPAGE>
    </PAGE>
  </SECTION>
</DOCUMENT>
```

Table 3 shows specific details of one implementation of the exemplary syntax 300 suitable for creation of a document similar to that seen in FIG. 6. Referring to Table 3, the document definition allows entry of a document name, in this case example3.dtd. Duplex printing and portrait paper orientation are selected. A section is defined, and named Section1. Margins of 0.25 inches are set. A first page is defined, and named FirstPage. Four regions are defined within the FirstPage definition. A region named Title is located according to the coordinates, X1=0; Y1=0; X2=1 and Y2=0.2. An image of JPEG type named titlebar.jpg is declared for display. Similarly, regions Image1, Column1 and Column2 are declared. Region Column1 declares a file named body.xm1 to be the content source, and also defines a NEXTREGION to be Column2. As a result, content beyond that which will fit within the region Column1 will flow into region Column2. For example, region Column2 similarly declares a NEXTREGION to be Column1, which is defined within the second page definition, BodyPage. The NEXTREGION link allows excess content to flow from a first region to a second region. For example, when content is added to a first region linked to a second region, excess content, i.e. content beyond that which will fit within the first region, flows into the second region. Content beyond the capacity of the second region would then flow into a region to which the second region is linked.

The second page definition, BodyPage, includes the definitions of two regions, Column1 and Column2, each of which define NEXTREGIONs. Due to the NEXTREGIONs defined, when Column1 of a first BodyPage is full of text, additional text is entered into Column2 of that page. When Column2 is filled with text, text is entered into Column1 of a second BodyPage, and so on.

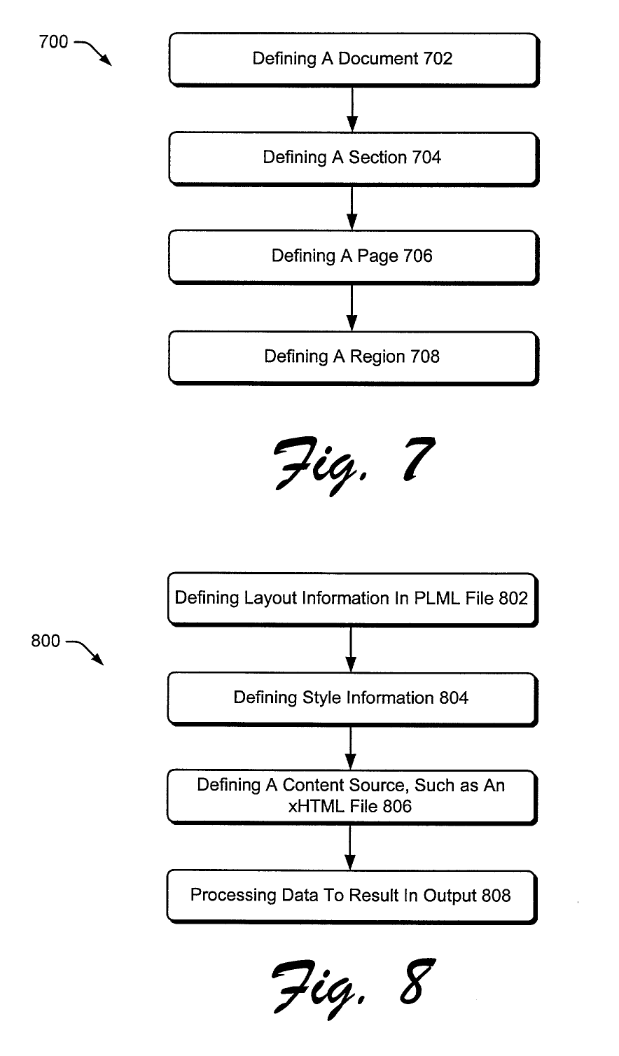

FIG. 7 shows a method 700 by which an exemplary version of a page layout markup language is used to author a document. At block 702, a document is defined. The document definition 302 allows an author to define characteristics of the document, which may include: one or more sections, selection or rejection of duplex (two-sided) printing, and to select landscape or portrait printing.

At block 704, a section definition 304 allows the author to define characteristics of the section, which may include: a section name, specification of one or more pages types within the section, an optional nextsection, margins and margin units. The NEXTSECTION element may be defined by the author, and consists of character data that is used to specify a logically linked section. The mechanism by which the link is made involves comparison of the NEXTSECTION element of the first section to the SECTIONNAME attribute of the second section. By linking two sections in this manner, the author allows content to flow between the two linked sections to result in advantageous layout of the document.

At block 706, a page definition 306 allows the author to define characteristics of the page, which may include: a page name, specification of one or more regions within the page and an optional nextpage reference. The NEXTPAGE element may be defined by the author, and consists of character data that is used to specify a logically linked page. The mechanism by which the link is made involves comparison of the NEXTPAGE element of the first page to the PAGENAME attribute of the second page. By linking two pages in this manner, the author allows content to flow between the two linked pages to result in advantageous layout of the document.

At block 708, a region definition 308 allows the author to define characteristics of the region, which may include: a region name, a location within a page for the region, the data type contained within the region, resources to allow assignment of absolute and/or relative values to margin parameters, and resources to allow control over image processing operators, such as z-order, shrink-to-fit, maintain-aspect-ratio, and clip. A NEXTREGION element may be defined by the author, and consists of character data that is used to specify a logically linked region. The mechanism by which the link is made involves comparison of the NEXTREGION element of the first region to the REGIONNAME attribute of the second region. By linking two regions in this manner, the author allows content to flow between the two linked regions to result in advantageous layout of the document.

FIG. 8 shows a method 800 by which a page layout markup language may be utilized to print or otherwise output a document. At block 802, layout information 102 is defined within a PLML file. The layout information may include a document definition 302, a section definition 304, a page definition 306 and a region definition 308.

At block 804, style information is defined. The style information may be included within a CSS2 file, style sheet or similar document.

At block 806, a source of content is provided. The content may be included within any appropriate data-containing object, such as an xHTML file. The content may consist of text, graphics or other information, in any combination.

At block 808, the PLML file, style information and content are processed to result in output. The processing of the layout information may be performed by a PLML interpreter, a PLML interpreter incorporated as a plug-in for a printer or associated adapter box or in any manner consistent with the processing of document type definitions. The output may be in the form of a printed document, a video image or other form, as desired.

### Conclusion

As seen above, a page layout markup language provides a syntax that allows an author to create a document using a plurality of definitions. The resulting document results in superior print, video or other output, based on better control over document layout and other factors.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A page layout markup language, comprising:
a document definition referencing at least one section;
a section definition, contained within the document definition, referencing at least one page;
a page definition, contained within the section definition, referencing at least one region;
a region definition, contained within the page definition, to display content; and
a link, contained within a syntax for the region definition, to associate a first region to a second region and allow excess content to flow from the first region to the second region.

2. The page layout markup language of claim 1, additionally comprising:
a link, contained within a syntax for the page definition, to associate a first page to a second page to allow excess content to flow from the first page to the second page.

3. The page layout markup language of claim 2, additionally comprising:
a link, contained within a syntax for the section definition, to associate a first section to a second section to allow excess content to flow from the first section to the second section.

4. The page layout markup language of claim 1, additionally comprising:
resources, contained within the page layout markup language, to allow assignment of absolute values to margin parameters.

5. The page layout markup language of claim 1, additionally comprising:
resources, contained within the page layout markup language, to allow assignment of relative values to margin parameters.

6. The page layout markup language of claim 1, additionally comprising:
an element, contained within the document definition, to allow selection and rejection of duplex printing.

7. The page layout markup language of claim 1, additionally comprising:
an element, contained within the document definition, to allow selection between landscape and portrait page orientation.

8. The page layout markup language of claim 1, additionally comprising:
resources, contained within the region definition, to allow control over at least one image processing operator, selected from among: shrink-to-fit, maintain-aspect-ratio, and clip.

9. A document, comprising:
a document definition;
a section definition contained within the document definition;
a page definition contained within the section definition;
a region definition contained within the page definition;
a link, contained within a syntax for the region definition, to associate a first region to a second region and allow content to flow between the first region and the second region;
a link, contained within a syntax for the page definition, to associate a first page to a second page and allow content to flow between the first page and the second page; and
a link, contained within a syntax for the section definition, to associate a first section to a second section and allow content to flow between the first section and the second section.

10. A document type definition, comprising:
a document definition referencing at least one section;
a section definition, contained within the document definition, referencing at least one page;
a page definition, contained within the section definition, referencing at least one region;
a region definition, contained within the page definition, to display content; and
a link, contained within a syntax for the region definition, to associate a first region to a second region and allow content to flow between the first region and the second region;
a link, contained within a syntax for the page definition, to associate a first page to a second page and allow content to flow between the first page and the second page; and
a link, contained within a syntax for the section definition, to associate a first section to a second section and allow content to flow between the first section and the second section.

11. An interpreter, to process a document, wherein the document comprises:
a document definition referencing at least one section;
a section definition, contained within the document definition, referencing at least one page;
a page definition, contained within the section definition, referencing at least one region;
a region definition, contained within the page definition, to display content;
a link, contained within a syntax for the region definition, to associate a first region to a second region and allow content to flow between the first region and the second region;
a link, contained within a syntax for the page definition, to associate a first page to a second page and allow content to flow between the first page and the second page; and
a link, contained within a syntax for the section definition, to associate a first section to a second section and allow content to flow between the first section and the second section.

12. The interpreter of claim 14, additionally comprising:
resources, contained within the region definition, to allow control over at least one image processing operator, selected from among: shrink-to-fit, maintain-aspect-ratio, and clip.

13. A method, comprising:
defining a document definition referencing at least one section;
defining a section definition, contained within the document definition, referencing at least one page;
defining a page definition, contained within the section definition, referencing at least one region;
defining a region definition, contained within the page definition, to display content;
linking a first region to a second region to allow excess content to flow from the first region to the second region; and
linking a first page to a second page to allow excess content to flow from the first page to the second page.

14. The method of claim 13, additionally comprising:
defining resources within the region definition, to allow control over at least one image processing operator, selected from among: shrink-to-fit, maintain-aspect-ratio, and clip.

15. A method of printing information, comprising:
defining layout information within a document definition;
linking a first region to a second region, both regions defined within the document definition, to allow content to flow between the first region and the second region;
linking a first page to a second page, both pages defined within the document definition, to allow content to flow between the first page and the second page;
defining style information within a style file;
providing a source to deliver content; and
processing the document definition, style information and content to display a document.

16. One or more processor-readable media having processor-readable instructions thereon which, when executed by one or more processors cause the one or more processors to:
define a document definition referencing at least one section;
define a section definition, contained within the document definition, referencing at least one page;
define a page definition, contained within the section definition, referencing at least one region;
define a region definition, contained within the page definition, to display content;
a link, contained within a syntax for the region definition, to associate a first region to a second region and allow content to flow between the first region and the second region;
a link, contained within a syntax for the page definition, to associate a first page to a second page and allow content to flow between the first page and the second page; and
a link, contained within a syntax for the section definition, to associate a first section to a second section and allow content to flow between the first section and the second section.

17. The processor-readable media of claim 16, which additionally cause the one or more processors to:
define resources within the region definition, to allow control over at least one image processing operator, selected from among: shrink-to-fit, maintain-aspect-ratio, and clip.
